(19) United States
(12) Patent Application Publication
(10) Pub. No.: US 2012/0267422 A1
(43) Pub. Date: Oct. 25, 2012

(54) SOLDERING ASSISTANCE DEVICE AND SOLDERING METHOD THEREOF

(75) Inventors: AI-YU PAN, Shenzhen City (CN); JIN-YOU WANG, Shenzhen City (CN); CHAO-RONG LAI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/166,792

(22) Filed: Jun. 22, 2011

(30) Foreign Application Priority Data
Apr. 22, 2011 (CN) 201110101728.X

(51) Int. Cl. B23K 31/02; B23K 3/08

(52) U.S. Cl. 228/179.1; 228/56.5

(57) ABSTRACT

A soldering assistance device is used for soldering a multi-pin electronic element with a row of pins on a PCB. The row of pins includes an outer pin at two ends thereof. The soldering assistance device includes a holding portion and a soldering portion connected to the holding portion. The soldering portion is adjacent to the outer pin. An interval between the soldering portion and the outer pin is less than an interval between each two adjacent pins of the row of pins. The soldering portion is made of a metal which is easy to solder. A soldering method using the soldering assistance device is also provided.

### BACKGROUND

1. Technical Field

The present disclosure relates to a soldering assistance device and a soldering method.

2. Description of Related Art

Multi-pin electronic elements with extending pins are connected to the circuitry of the printed circuit boards (PCB) by soldering the pins into preexisting holes of the PCB. In soldering process, a soldering iron holds a quantity of molten solder. The soldering iron moves in a direction across a row of pins. The molten solder contacts with the bottom of the PCB and simultaneously wets the pins. Upon moving past the molten solder, excess solder drains away and a quality solder joint remains between the pins and the PCB, thereby the solder joint attaches the pins to the PCB. However, the surface tension between the soldering iron and molten solder is less than that between the molten solder and the pins at the several last pins. That is because the contact area between the molten solder and the pins decreases. The excess solder will remain on the several last pins and bridge the gap between the several last pins, thus, will result in a short circuit.

What is needed, therefore, is a soldering assistance device capable of overcoming the described limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is a schematic view of a soldering assistance device according to an embodiment, together with a multi-pin electronic element and a circuit board.

FIG. 2 is a schematic view of the assistance device of FIG. 1 after the soldering process is completed.

FIG. 3 is a flow chart of a soldering method using the assistance device of FIG. 1.

### DETAILED DESCRIPTION

Embodiments of the present disclosure are described in detail as follows, with reference to the accompanying drawings.

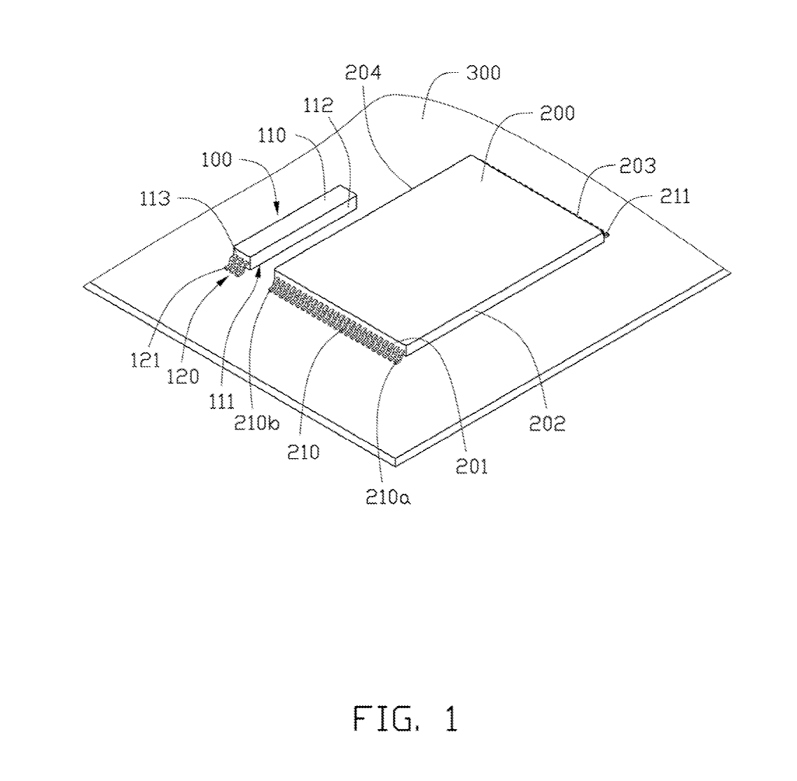

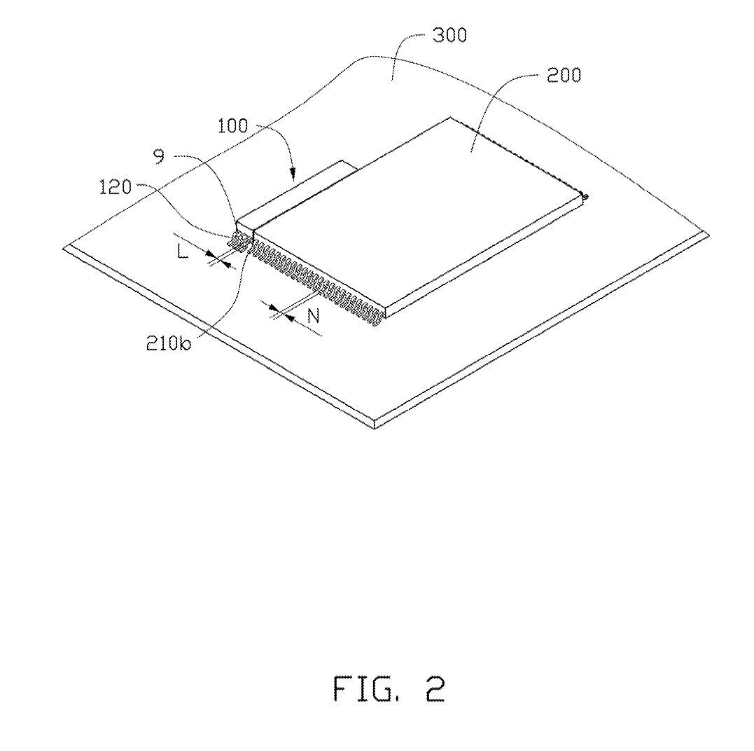

Referring to FIGS. 1 and 2, a soldering assistance device 100, according to an embodiment is shown. The device 100 is positioned at a side of a multi-pin electronic element 200. In this embodiment, the multi-pin electronic element 200 is a microchip. The multi-pin electronic element 200 includes a first side wall 201, a second side wall 202, a third side wall 203, and a fourth side wall 204 connected end to end. A first row of pins 210 and a second row of pins 211 are positioned at the first side wall 201 and the third side wall 203 respectively. The first row of pins 210 includes a first outer pin 210a and a second outer pin 210b at two opposite ends of the first side wall 201.

In soldering process, the assistance device 100 is positioned on a circuit board 300 with the multi-pin electronic element 200 soldered thereon. The assistance device 100 is adjacent to the first outer pin 210a or the second outer pin 210b based on the soldering sequence of a soldering iron (not shown). In the present embodiment, the assistance device 100 is adjacent to the second outer pin 210b, the soldering iron holding molten solder 9 moves from the first outer pin 210a to the second outer pin 210b.

The soldering assistance device 100 includes a holding portion 110 and a soldering portion 120. In the present embodiment, the holding portion 110 is a narrow cuboid. The thickness of the holding portion 110 along a direction vertical to the circuit board 300 is substantially equal to that of the multi-pin electronic element 200. The holding potion 110 includes a bottom surface 111, a first side surface 112, and a second side surface 113 connected to the first side surface 112. The bottom surface 111 attaches to the circuit board 300. The first side surface 112 resists against the fourth side wall 204 of the multi-pin electronic element 200.

The soldering portion 120 is fixed on the second side surface 113 of the holding portion 110. The soldering portion 120 is made of metal, which is easy to solder. In other embodiments, the soldering portion 120 can be made of copper, nickel, gold, silver, or tin-plated nickel. The soldering portion 120 is adjacent to the second outer pin 210b. The interval L between the soldering portion 120 and the second outer pin 210b is less than an interval N between each two adjacent pins 210 of the multi-pin electronic element 200. The interval L between the soldering portion 120 and the second outer pin 210b is less than or equal to 1 mm. The soldering portion 120 includes at least two soldering pins 121. In the present embodiment, the soldering portion 120 includes three soldering pins 121. The interval L between the second outer pin 210b and the nearest soldering pin 121 is 1 mm.

The second outer pin 210b and the soldering portion 120 get a larger contact area, when the molten solder 9 flows on the second outer pin 210b and the soldering portion 120. The soldering portion 120 will attract the molten solder 9 and the molten solder 9 will stay on the soldering portion 120. That will prevent the molten solder 9 from reflowing to the first row of pins 210. The first row of pins 210 will not cause a short-circuit. When the molten solder 9 is cold, the molten solder 9 will stay on the soldering portion 120. The molten solder 9 can be removed from the soldering portion 120 after the soldering process is completed. The assistance device 100 can be reused.

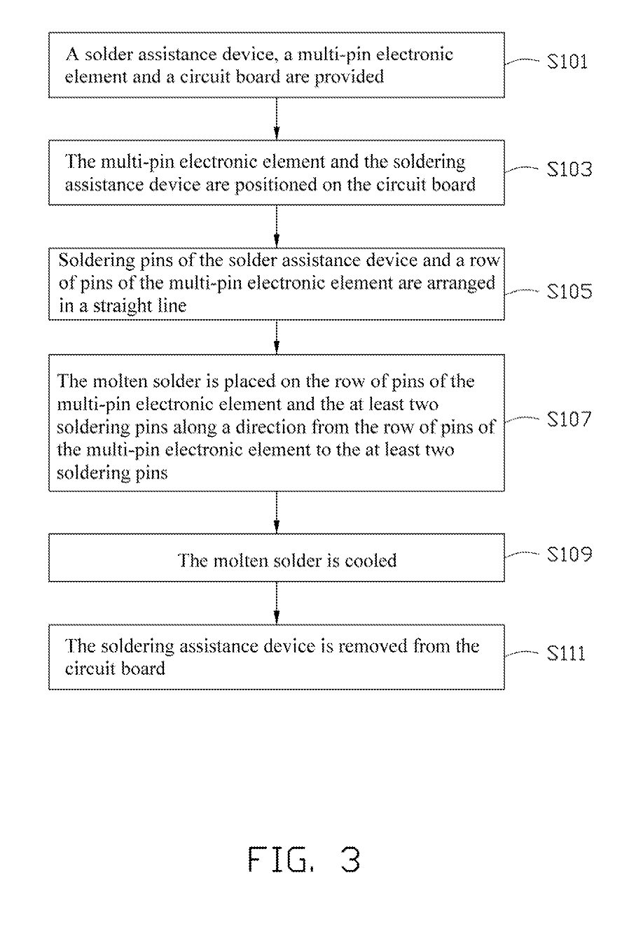

Referring to FIG. 3, one embodiment of a soldering method for a multi-pin electronic element 200 is shown. The method is as follows.

In step S101, the solder assistance device 100, the multi-pin electronic element 200 and the circuit board 300 are provided. The soldering assistance device 100 includes the holding portion 110 and the soldering portion 120. The holding portion 110 includes the bottom surface 111, a first side surface 112, and a second side surface 113 connected to the first side surface 112. The bottom surface 111 attaches to the circuit board 300. The first side surface 112 resists against the fourth side wall 204 of the multi-pin electronic element 200. The soldering portion 120 is positioned on the second side surface 113. The soldering portion 120 includes at least two soldering pins 121. The at least two soldering pins 121 are made of metal material. The multi-pin electronic element 200 includes a row of pins.

In step S103, the multi-pin electronic element 200 and the soldering assistance device 100 are positioned on the circuit board 300.

In step S105, the at least two soldering pins 121 and the row of pins 210 of the multi-pin electronic element 200 are arranged in a straight line. The interval L between the soldering portion 120 and the first row of pins 210 of the multi-pin electronic element 200 is less than the interval N between each two adjacent pins 210 of the multi-pin electronic element 200.

In step S107, the molten solder 9 is placed on the row of pins 210 of the multi-pin electronic element 200 and the at least two soldering pins 121 along a direction from the row of pins 210 of the multi-pin electronic element 200 to the at least two soldering pins 121.

In step S109, the molten solder 9 is cooled.

In step S111, the soldering assistance device 100 is removed from the circuit board 300.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

1. A soldering assistance device for soldering a row of pins of a multi-pin electronic element on a circuit board, the multi-pin electronic element comprising a row of pins on a sidewall thereof, the soldering assistance device comprising:
a holding portion comprising a side surface; and
a soldering portion positioned on the side surface and comprising at least two soldering pins, the at least two soldering pins being made of metal material;
wherein the soldering assistance device is positioned on the circuit board adjacent to the multi-pin electronic element in a soldering process, the at least two soldering pins of the soldering portion and the row of pins of the multi-pin electronic element are arranged in a straight line, and an interval between the soldering portion and the row of pins is less than an interval between each two adjacent pins of the multi-pin electronic element.

2. The soldering assistance device as claimed in claim 1 wherein the soldering portion is made of material selected from the group consisting of copper, nickel, gold and silver.

3. The soldering assistance device as claimed in claim 1, wherein the soldering portion is made of tin-plated nickel.

4. The soldering assistance device as claimed in claim 1, wherein the soldering portion comprises three soldering pins.

5. The soldering assistance device as claimed in claim 1, wherein the holding portion is a substantial cuboid.

6. A soldering method, comprising:
providing a soldering assistance device, a multi-pin electronic element and a circuit board, wherein the soldering assistance device comprises a holding portion and a soldering portion, the holding portion comprises a side surface, the soldering portion is positioned on the side surface and comprises at least two soldering pins, the at least two soldering pins are made of metal material, the multi-pin electronic element comprises a row of pins;
positioning the multi-pin electronic element and the soldering assistance device on the circuit board;
arranging the at least two soldering pins and the row of pins of the multi-pin electronic element in a straight line, wherein an interval between the soldering portion and the row of pins of the multi-pin electronic element is less than an interval between each two adjacent pins of the multi-pin electronic element;
placing molten solder on the row of pins of the multi-pin electronic element and the at least two soldering pins along a direction from the row of pins of the multi-pin electronic element to the at least two soldering pins;
cooling the molten solder; and
removing the soldering assistance device from the circuit board.

7. The soldering method as claimed in claim 6, wherein the interval between the soldering portion and the row of pins of the multi-pin electronic element is equal to 1 mm.

8. The soldering method as claimed in claim 6, wherein a thickness of the holding portion along a direction vertical to the circuit board is substantially equal to that of the multi-pin electronic element.
